(19) United States
(12) Patent Application Publication
(10) Pub. No.: US 2012/0259918 A1
(43) Pub. Date: Oct. 11, 2012

(54) BUSINESS PROCESS MANAGEMENT SYSTEM WITH IMPROVED COMMUNICATION AND COLLABORATION

(75) Inventors: Eran M. BRINGER, Yuvalim (IL); Hagit HAMDANI, Ashdod (IL); Avshalom HOURI, Netivot (IL); Alexander PYASIK, Maaleh-Adumim (IL); Aviram SEGAL, Kiryat-Gat (IL); Ofira TAL-AVIV, Moshav Bitzaron (IL); Daniel M. YELLIN, Raanana (IL); Yifat YULEVICH, Bazra (IL)

(73) Assignee: INTERNATIONAL BUSINESS MACHINES CORPORATION, Armonk, NY (US)

(21) Appl. No.: 13/082,296

(22) Filed: Apr. 7, 2011

(51) Int. Cl. G06F 15/16

(52) U.S. Cl. 709/204

(57) ABSTRACT

Techniques are provided for enabling communications between a business process and an external entity, by a) receiving notification data from a business process of a computer-based business process management system, b) applying a set of rules to any of the notification data to select an external entity to whom a communication will be sent, select a communications channel from among a plurality of communications channels associated with the external entity, and generate the communication from any of the notification data in a manner that conforms to the selected communications channel, and c) sending the communication to the external entity via the selected communications channel.

### BACKGROUND

Embodiments of the invention relate to business process management systems and communication and collaboration systems in general.

In a typical business process management (BPM) system business processes are modeled and implemented by a business process server. Occasionally, a business process has a requirement that it cannot fulfill by itself, such as by accessing other computer-based applications or data repositories, and thus requires that an action be taken by an entity that is external to the business process server environment, such as where the external entity provides data to the business process. To accommodate such situations, a business process may communicate directly with the external entity. Often, this entity is itself a computer system, and the business process communicates with this computer system by invoking a service provided by this computer system. Sometimes the entity with which the business process needs to communicate is a human. However, current techniques for enabling business processes to communicate with external human entities provide only limited functionality in this regard.

### SUMMARY

Embodiments of the invention include a method, system and computer program product for enabling communications between a business process and an external entity, including receiving notification data from a business process of a computer-based business process management system, applying a set of rules to any of the notification data to select an external entity to whom a communication will be sent, select a communications channel from among a plurality of communications channels associated with the external entity, and generate the communication from any of the notification data in a manner that conforms to the selected communications channel, and sending the communication to the external entity via the selected communications channel.

### BRIEF DESCRIPTION OF THE SEVERAL VIEWS OF THE DRAWINGS

The invention will be understood and appreciated more fully from the following detailed description taken in conjunction with the appended drawings in which:

FIG. 1 is a simplified conceptual illustration of a Business Process Management and Communications system, constructed and operative in accordance with certain embodiments of the invention;

FIG. 2 is a simplified flowchart illustration of an exemplary method of operation of the system of FIG. 1, operative in accordance with certain embodiments of the invention;

FIG. 3 is a simplified flowchart illustration of an exemplary method of operation of the system of FIG. 1, operative in accordance with certain embodiments of the invention; and

FIG. 4 is a simplified block diagram illustration of an exemplary hardware implementation of a computing system, constructed and operative in accordance with certain embodiments of the invention.

### DETAILED DESCRIPTION

The invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet External entity).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

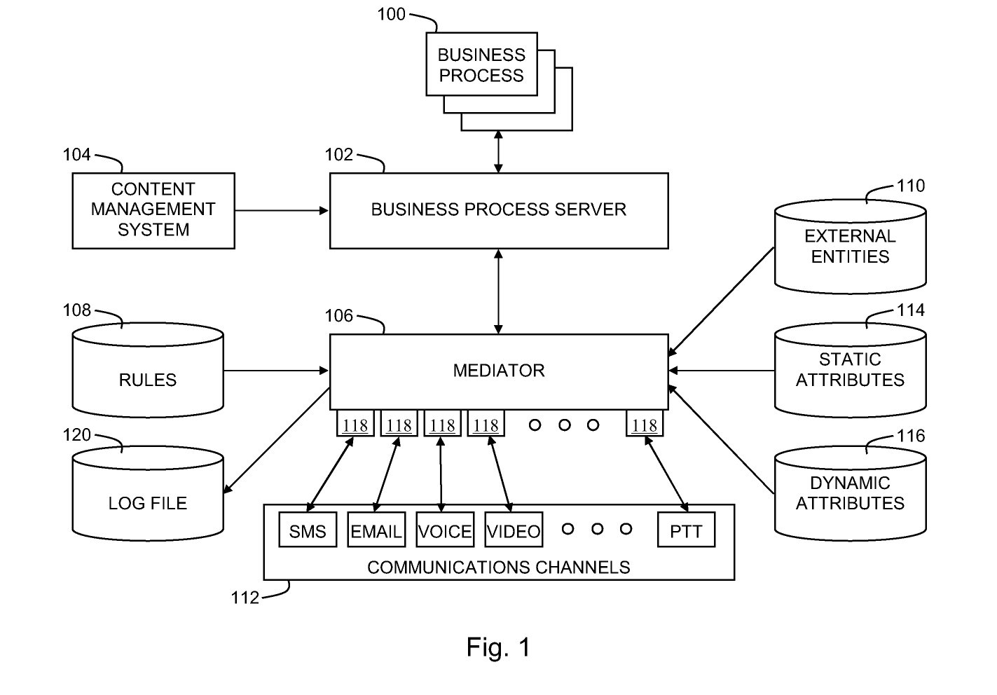

Reference is now made to FIG. 1, which is a simplified conceptual diagram of a Business Process Management and Communications system, constructed and operative in accordance with certain embodiments of the invention. In the system of FIG. 1 one or more business processes 100 are implemented by a business process server 102 in accordance with conventional techniques. Business process server 102 is preferably configured to access one or more content management systems 104 for retrieving documents for collaboration and for populating e-meetings and team rooms with such documents. A mediator 106 is configured to receive notification data from any of the business processes 100 via business process server 102, typically where an event occurs at a particular business process 100 that requires input or action by an external entity, such as a person having a particular set of attributes. Mediator 106 preferably applies a predefined set of rules 108 to any of the notification data received from business process server 102 in order to select one or more external entities 110 to whom communications will be sent, select one or more communications channels (or mediums) from among a plurality of communications channels 112 associated with the selected external entities 110, and generate the communications from any of the notification data in a manner that conforms to the selected communications channels 112, whereupon business process server 102 sends the communications to the selected external entities 110 via the selected communications channels 112. If the notification data indicates that a response from any selected external entity 110 is optional or mandatory, mediator 106 preferably awaits receipt of such a response and takes one or more actions when a response is or is not received as may be indicated by the requesting business process 100 and/or any applicable rules 108.

In applying rules 108 to select an external entity 110 and a communications channel 112, mediator 106 is preferably configured to receive or otherwise access one or more static attributes 114 associated with one or more of the external entities 110. Mediator 106 is also preferably configured to receive or otherwise access one or more dynamic attributes 116 associated with one or more of the external entities 110, which may include presence or “awareness” information as may be provided by a presence server (not shown) in accordance with conventional techniques. Using the static attributes 114 and dynamic attributes 116 associated with one or more of the external entities 110, mediator 106 preferably applies rules 108 to select one or more external entities 110 that are “best” qualified to provide whatever input and/or actions are required by the particular business process 100 that provided the notification data to mediator 106.

In certain embodiments, selection of an external entity 110 may be based on various characteristics, such as an individual's skills, role, location, individual communication history and professional record, as well as, dynamic information such as an individual's location (e.g., GPS location), whether the individual is on-line at a computer, whether the individual is at the office or not, awareness, and availability to handle a new work request at the current time. By using those capabilities, the business process is able to address requests to specific individuals, specific roles in the organization or to individuals with specific static and dynamic capabilities, and mediator 106 determines the best person to handle the request, based upon the specifics of this request. For instance, the business process may need someone to handle a request to have access to a physical location (perhaps to check on the status of some equipment). Mediator 106 can find the appropriate person with proximity to this location and set of the relevant skills to fulfill the request.

Static attributes 114 are attributes that require manual updating. Examples of static attributes include user preferences (e.g., communication preferences, such as whether the user prefers voice or email, and communication capabilities, such as whether the user's phone support chat services) which are infrequently updated by the user, or user skills, which are infrequently updated by the user or an administrator when a user acquires new skills, such as by completing a course. User preferences may also be described as preferences of an individual.

Dynamic attributes 116 are attributes that are automatically updated without direct human intervention. Examples of dynamic attributes include an individual's Global Positioning System (GPS) coordinates, which are automatically provided by a GPS device when there is a change in an individual's current location. Another example is amount of time an individual has been on shift, which is automatically and periodically computed by checking the time that the individual informed a computer-based system, such as via a Short Message Service (SMS) message, as the time that he started his shift. As another example, the workload of an individual constantly changes as he is given new tasks to perform and as he finishes already assigned tasks. This information may be maintained in a computer-based system, and as changes occur, the system automatically notifies a presence server that updates this attribute in real-time, where the attribute can be directly accessed by business process server 102.

Since dynamic attributes typically change very frequently, a different computing infrastructure is preferably used to automatically update and store dynamic attributes 116 than that which is used to manually update and store static attributes 114 that typically change infrequently. The infrastructure for updating and storing dynamic attributes 116 is preferably configured to handle in real-time vast amounts of messages describing changes to attribute values, and to update the attributes in real-time based upon these messages. Business processor server 102 is preferably configured to access this infrastructure as required to ensure that it has up-to-date values for dynamic attributes 116.

The application of rules 108 by mediator 106 to static attributes 114 typically differs from the application to dynamic attributes 116, which must take into consideration that dynamic attribute values typically change more frequently than static attribute values. For example, where static attributes are concerned, where mediator 106 identifies two individuals who have appropriate skills to perform a particular task, mediator 106 may contact one of them. If the contacted individual cannot handle the task, mediator 106 may contact the second individual, relying on the high probability that the second person's skills have not changed in the meantime. In contrast, where dynamic attributes are concerned, where mediator 106 identifies two individuals who are close to a particular location based upon their current GPS coordinates, mediator 106 may contact one of them. If the contacted individual cannot handle the task, mediator 106 cannot safely assume that the second individual is still appropriate for this task, as his/her GPS coordinates may have changed in the meantime. Depending on the length of time that has transpired, mediator 106 may need to recompute the appropriate set of people closest to the desired location.

Rules 108 may dictate policies governing the selection of communications channels 112, allowing mediator 106 to make decisions in various situations to select the most appropriate communications channel 112 for communication with a selected external entity 110. Thus, context-driven communication may be supported for communications channel selection, where consideration is given to information such as external entity awareness, an emergency level associated with the notification data, and previous communication attempts with an external entity, such as is shown in Table A below:

| Request | Previous | | | |
|---|---|---|---|---|
| attempt | attempts | Emergency | Awareness | Selected Channel |
| First try | N/A | High | On-Line | Instant Messaging |
| | | | !On-Line | Voice |
| | | Normal | On-Line | Instant Messaging |
| | | | !On-Line | SMS |
| Escalation - | Voice | High | On-Line | Instant Messaging |
| 10 minutes - | | | !On-Line | SMS |
| claim delay | | Normal | On-Line | Instant Messaging |
| | | | !On-Line | eMail |
| Escalation - | Sametime | High | On-Line | Voice |
| 10 minutes - | | | !On-Line | Voice |
| claim delay | | Normal | On-Line | eMail |
| | | | !On-Line | SMS |

Rules 108 may also dictate whether and how communications to and from communications channels 112 and to and from business processes 100 are to be translated. Thus, for example, where the notification data received from a business process 100 includes the text directives “ask Mary the number of widgets she wants ordered” or “tell someone to check emergency valve in warehouse on 5th street”, rules 108 may dictate that the text be translated into other formats as appropriate to a selected communications channel 110. Likewise, a report of an emergency may be forwarded by a business process 100 to mediator 106 as “C12, 34.831841149828655-86.6436767578125”, giving the code of the emergency and the GPS coordinates, whereupon mediator 106 uses rules 108 to interpret this code and augments the coordinates with an address, such that the message is translated into a human-consumable format such as “Alert. Fire at 12th and Main.” when mediator 106 communicates the message to a selected external entity 110 via a selected communications channels 112.

Communications channels 112 may include multiple communications media, such as computers, cellular telephones, and any other known communications media, that may be accessed using any known communications protocol, such as e-mail, SMS, Instant Messaging (IM), walkie-talkie, voice (regular or Internet Protocol (IP) telephony), video chat, Facebook, Twitter, and e-meeting protocols. (Facebook is a trademark or registered trademark of Facebook, Inc. in the United States, other countries or both. Twitter is a trademark or registered trademark of Twitter, Inc. in the United States, other countries or both.) Communications channels 112 may, for example, be implemented in the context of a unified communication and collaboration system in accordance with conventional techniques. Mediator 106 may have one or more adaptors 118 that enable mediator 106 to communicate via any of the communications channels 112. Adapters 118 may support synchronous or asynchronous communications, and may expose synchronous interfaces while implementing asynchronous interaction. Adapters 118 may support authentication, channel management, mediation, and activation of listeners in accordance with conventional techniques as required by the communications channels 112.

To summarize the above, mediator 106 may, for example, apply a particular rule 108 to notification data received from a particular business process 100, where the rule states that if the notification data includes data A, those external entities 110 that have static attribute B, such as a particular skill, are to be found, and of these external entities 110 having static attribute B, one external entity is to be selected having a dynamic attribute C, such as a GPS location, that is closest to a value D, such as a GPS location indicated in the notification data. The particular rule 108 may also state that a communication be sent to the selected external entity 110 via the two communications channels 112 most recently used by the selected external entity 110, such as a computer at a particular network address and a cellular telephone at a particular number. Mediator 106 may receive a response from the selected external entity 110, which response mediator 106 may forward to the requesting business process 100, optionally, applying any applicable rules 108 before forwarding the response to the requesting business process 100, such as to reformat the response data into a machine-readable format.

Mediator 106 performs optimization by finding the “best” person and “best” communications channel. Mediator 106 is preferably configured to log any of the communications it sends or receives, as well as, any of the actions it performs, in a log file 120. Mediator 106 may also enforce security and privacy policies.

Notification data that is sent by a business process 100 to mediator 106 may, for example, include a message such as “Notify person X (or a person with attributes A, B, and C) about M”, where M includes information that is to be sent to the selected person, and where no response from the person is required. Alternatively, the notification data may, for example, include a message such as “Notify person X (or a person with attributes A, B, and C) about M and get back R from him”, where R represents a response that the person is required to provide. For either of these messages, if the requesting business process 100 did not specify the individual to contact, but specified attributes instead, mediator 106 preferably attempts to find the “best” person to send the message to. If mediator 106 does not receive a reply within a given amount of time, or the reply indicates that the person is unable or unwilling to attend to the matter indicated in the message, rules 108 will preferably indicate to mediator 106 whether to resend the message to someone else and/or take other actions. If the message requires a response and mediator 106 receives a reply including the required response data, mediator 106 preferably forwards the response data to the requesting business process 100, which may use the response to control the future execution of the business process.

Mediator 106 is also preferably configured to receive user-initiated requests via any communications channel 110 and apply rules 108 to determine whether and where to forward the requests to business processes 100, as well as whether and how to translate the requests.

Application of the system of FIG. 1 may be demonstrated in the context of the following specific examples.

### Sensor Events

The system of FIG. 1 may be used to respond to sensor events. As the world becomes increasingly instrumented, more and more digital input from sensors needs to be analyzed and acted upon. If a sensor from a bridge indicates abnormal conditions, or a sensor in a warehouse indicates suspicious activity, a request to handle the event is embodied in notification data sent by a business process 100 to mediator 106. Applying rules 108, mediator 106 determines that an appropriate team should be alerted and dispatched to investigate. This entails mediator 106 using both static attributes about teams and team members, such as skills and equipment, as well as dynamic attributes, such as location and status, to assemble the best teams to respond to the emergency. Mediator 106 contacts each team and/or team member by an appropriate communications channel, which may include voice messages, instant messages, SMS, or press-to-talk messages. Mediator 106 receives a reply from each team and/or team member, and if a team is not available, or cannot make it to the event site within a predefined required response time, mediator 106 finds a replacement team and contacts them. Mediator 106 tracks the progress of each team that reaches the event site, and facilitates communication between a central emergency controller and the various teams.

### User-Initiated Loan Requests

The system of FIG. 1 may be used to process loan requests, where a bank customer submits a request for a loan to mediator 106 via any communications channel 110, which request mediator 106 forwards to business process server 102, where one or more business processes 100 process the request. Where a particular business process 100 needs to get additional information from the customer, the particular business process 100 sends notification data to mediator 106, which then selects an appropriate communications channel 110 and contacts the customer, such as via chat or SMS. After receiving the information, mediator 106 forwards the information to the requesting business process 100. After gathering all the information, a loan officer reviews the request and decides to grant the loan. However, a final approval is required from the VP for Consumer Credit, who is currently on business trip, and is not able to access the bank's loan system. The approval request is therefore sent from the relevant business process 100 to mediator 106, which then routes the request to the VP's phone. The VP reviews the request and verbally approves the loan. Using conventional translation techniques, and in accordance with rules 108, mediator 106 translates the verbal response into a text-based response that is formatted for use by business process 100. Mediator 106 archives the conversation for later tracking and audit requirements.

Notification data sent from business processes 100 to mediator 106 may be formatted using the following Common Mediation Format (CMF) that has three parts:

<Recipient>
<Outgoing message>
<Return message>

where <Recipient> identifies the target of the message, <Outgoing_message> describes the message to be communicated to the <Recipient>, and <Return_message> is the message returned by the <Recipient> (if such a return message is required). The CMF allows a business process to state in simple terms with whom it wants to communicate, what information should be conveyed to the recipient, and what information is expected to be returned. The information returned by mediator 106 to a requesting business process 100 is likewise preferably expressed as structured data.

<Recipient> preferably specifies the external entity with whom a business process wishes to communicate, such as:

<Recipient name=“Dr_Alex_Pyasic@hospital.com”/>

Alternatively, <Recipient> may specify a set of mandatory and/or preferred attributes of the external entity such as:

<Recipient role=“Hospital administrator”, location=“Building 7”/>

in which case mediator 106 selects an external entity whose role is “Hospital administrator” and whose current location is Building 7.

As another example, <Recipient> may specify the attributes such as:

<Recipient role = ″Emergency responder″, close-to = ″Building 7″,
work-status = “On-duty”/>

in which case mediator 106 may be configured to apply rules 108 to external entities 110 based on their static and dynamic attributes and find the “best” external entities 110 to handle this request, where “best” is defined by rules 108.

Alternatively, <Recipient> can be a specific ID that a particular business process 100 previously received from mediator 106, identifying an external entity it communicated with in a previous message m. The same ID may be specified to ensure that a subsequent message is sent to the same individual to which m was sent.

<Outgoing_message> typically includes a text message, such as:

<Outgoing_message msg = “Consultation for patient John
Murphy waiting in your inbox. Please fill out prescription.” />

<Outgoing_message> may include communications channel-agnostic attributes, such as:

<Outgoing_message msg= “New patient consultation
waiting for your review”, riority = “high” />

which indicates to mediator 106 to treat this message with high priority. Depending on the communications channel 110 chosen, mediator 106 may handle high-priority messages in a special way, such as by sending a special alert to the recipient, or by visually highlighting the message.

<Outgoing_message> may, optionally, include communications channel-specific attributes, such as:

<Outgoing_message msg = “New patient consultation waiting
for your review”, if_SMS = “long_beep”, if_IM = “flash” />

which indicates that if the selected communications channel 110 is SMS, then a long beep should be produced when the message arrives at its destination, whereas, if the selected communications channel 110 is an instant messaging client, then the recipient's electronic display should be made to flash when the message arrives at its destination.

<Return_message> may include one or more structured fields to be returned from the external entity to the business process. Each structured field is preferably in the form:

<fieldName: fieldType>

such as in the following example:

<ToPrescribe: boolean /> // specialist decision whether to
prescribe medication for this patient
<Drug: String / > // if ToPrescribe is ”True”, then the name of
drug to prescribe
<Dosage: Real /> // dosage to take
<Metric: {mml, tablespoons, ...} /> // the dosage given above
is specified using this metric

Thus, for example, a message received from an external entity for forwarding to a particular business process 100 may appear as follows:

<ToPrescribe Yes />
<Drug “Amoxcillan” />
<Dosage 2 />
<Metric tablespoons />

Optionally, each structured field may include an attribute “Description” that provides information about the field and that may be relayed to the external entity in a communications channel-dependent fashion, such as:

<Drug “Amoxcillan”, description=“Enter registered name of drug”/>

The following CMF message summarizes the message that would be sent from the mediator to the appropriate doctor as described above:

```
<Recipient name= “Dr_Alex_Pyasic@hospital.com” />
<Outgoing_message msg = “Consultation for patient John Murphy
waiting in your inbox. Please fill out prescription.” />
<Return-Message id = XXX>
    <ToPrescribe: boolean />
    <Drug: String / >
    <Dosage: Real />
    <Metric: {mml, tablespoons, ...} />
<\ Return-Message >
```

The CMF message returned from the doctor to the requesting business process 100 would have the following form, as described above:

```
<Return-Message id = XXX>
    <ToPrescribe True />
    <Drug “Amoxcillan” />
    <Dosage 2 />
    <Metric tablespoons />
<\ Return-Message >
```

The ID in the Return-Message element enables the requesting business process 110 to associate the response with the original request.

Additionally or alternatively, eXtensible Markup Language (XML) Schema and other structured data mechanisms may be used to specify additional constraints on relationships between different elements of the <Outgoing_message> fields. Thus, in the above example, it may be specified that only if the “ToPrescribe” field has a value of “Yes” are the other fields non-empty.

The CMF format described above is just one of many possible formats that can be used. It is appreciated that those skilled in the art may implement the concepts described above using other formats.

Any of the elements shown in FIG. 1 are preferably implemented by one or more computers by implementing any of the elements shown in FIG. 1 in computer hardware and/or in computer software embodied in accordance with conventional techniques.

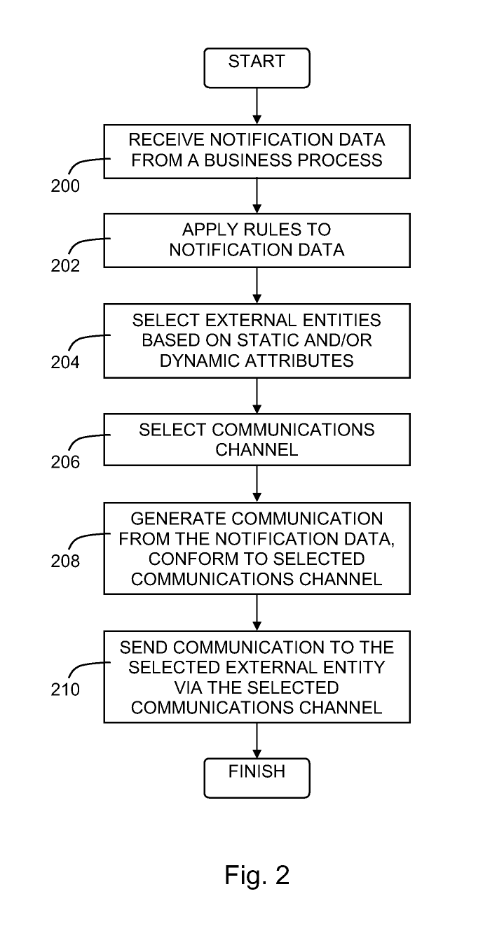

Reference is now made to FIG. 2, which is a simplified flowchart illustration of an exemplary method of operation of the system of FIG. 1, operative in accordance with certain embodiments of the invention. In the method of FIG. 2, notification data is received from a business process of a computer-based business process management system (block 200). One or more predefined rules are applied to any of the notification data (block 202) to select one or more external entities to whom a communication will be sent, such as by selecting an external entity based on a combination of the entity's static and dynamic attributes (block 204). One or more communications channels are selected from among a plurality of communications channels associated with a selected external entity (block 206) using, for example, the presence server. A communication is generated from any of the notification data in a manner that conforms to the selected communications channel (block 208). The communication is sent to the selected external entity via the selected communications channel (block 210).

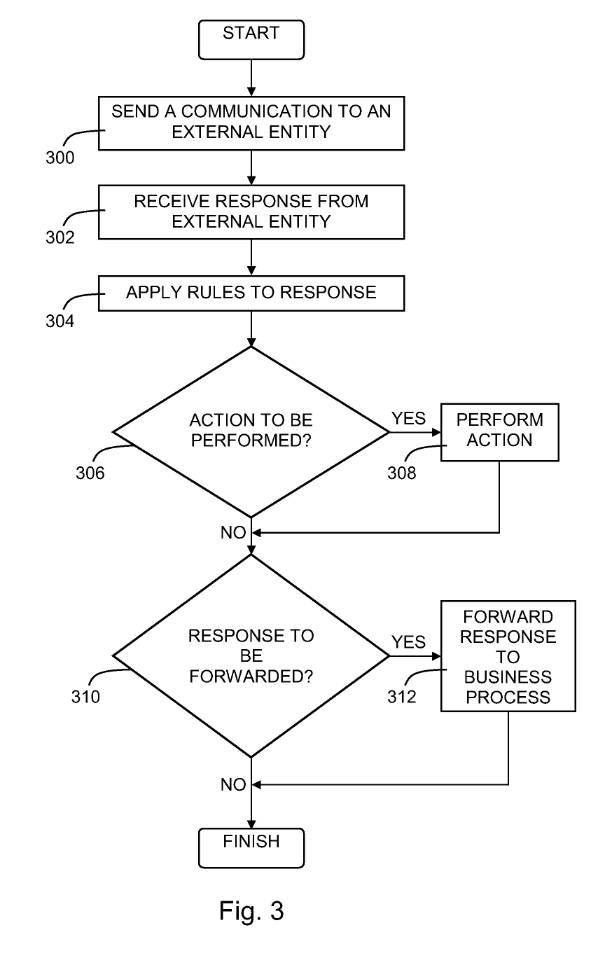

Reference is now made to FIG. 3, which is a simplified flowchart illustration of an exemplary method of operation of the system of FIG. 1, operative in accordance with certain embodiments of the invention. In the method of FIG. 3 a communication is sent to an external entity (block 300), such as in the manner described hereinabove with reference to FIG. 2. A response is received from the external entity (block 302), such as where the external entity indicates acceptance of a task or provides data that is to be provided to a business process. One or more predefined rules are applied to the response (block 304) to determine if an action is to be performed (blocks 306, 308), such as to select another external entity if the task is not accepted, and/or if the response is to be forwarded to a business process (blocks 310, 312). In particular, in block 306, if it is determined that an action is to be performed, processing continues to block 308 to perform the action, otherwise, processing continues to block 310. In block 310, if it is determined that the response is to response is to be forwarded, processing continues to block 312 to forward the response to a business process, otherwise, processing is finished.

In certain embodiments, for each of a plurality of external entities, the external entity and the communications channel are selected, and a collaborative communications session is initiated between the external entities.

In certain embodiments, any of the notification data and the communication are maintained in a history data file on a computer-readable data storage device. In certain embodiments, any of the notification data, the communication, and reply data are maintained in a history data file on a computer-readable data storage device.

Embodiments prescribe a common mediation format allowing a business process to state in simple terms the characteristics of the person whom it wants to communicate with, what information should be conveyed to the recipient, and what information is expected to be returned. This information is expressed in a structured form, suitable to the business process. Mediator 106 turns this request into a human-consumable format (natural language) that can be read and acted upon by an individual. Similarly, the responses from an individual are translated into this structured format consumable by the business process. Mediator 106, in that case, correlates between the individual response and the appropriate business process.

Mediator 106 optimizes the human interaction aspects of the business process so that: the request is dispatched to one or more optimal individuals to handle this request, the optimal communication mechanism is used to communicate with the one or more individuals, and a history of previous requests and communications is used to generate follow-up and escalation messages, to influence to whom to send future requests for optimal response, and what communication mechanisms to use in the future for optimal response.

Mediator 106 and the format used to communicate between the business process and mediator 106 hide communication specific details from the business process designer, allowing changes in the business process to leverage changes in the communication layer without being modified.

Mediator 106 provides extension to business process agility through a comprehensive set of collaborative services to provide capabilities allowing more sophisticated people assignment, communications channel selection, mass notification and escalation mechanisms, etc. This is especially helpful as the number of communications channels continues to increase, as well as the number of new collaborative services.

With embodiments, the definition of a business process requiring human interaction can be specified without any knowledge of how the interaction will be accomplished (e.g., without any knowledge of the communications channel for interacting with the individual). Embodiments therefore allow a business process integration developer to author business processes, and those responsible for communication/collaboration to author the communication mechanisms. Embodiments allow changing (i.e., adding or deleting) communication policies (such as those shown in Table A above) or communications channels without the need to change the business process.

Embodiments allow the same business process to use various communications channels at different process stages, without affecting the logic of the business process. For instance, a business process might require multiple interactions between the business process and an individual. That individual may switch communications channels—e.g., may use a handheld (SMS, chat or voice) to communicate with the process before reaching the office, and later on continue to communicate with the business process using the applications in the office, without the business process needing to be aware of this change, and without affecting the execution of the business process.

Thus, mediator 106 analyzes and decomposes a request from a business process, determines whom the recipient is (if required), determines what communications channel to use to contact the recipient (if required), translates between the common mediation format to a format specific to that communications channel, uses Application Program Interfaces (APIs) for that communications channel to send and receive back replies from the communications channel, translates the received message, and sends the message to the business process.

Embodiments describe a business process that wants to communicate with humans and mediator 106 that bridges between the structured format of business processes and the unstructured natural language needed to communicate with humans. Embodiments focus on finding the right person to perform the task for the business process.

Mediator 106 is bidirectional in that it is possible to invoke business process related functions (e.g., business process initiation, human task claiming, etc.) using communications channels and vice versa.

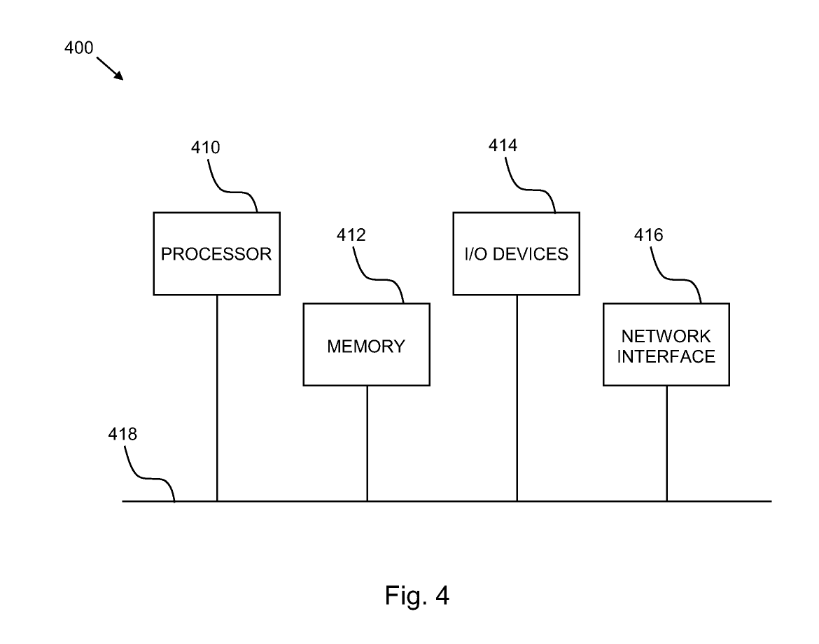

Referring now to FIG. 4, block diagram 400 illustrates an exemplary hardware implementation of a computing system in accordance with which one or more components/methodologies of the invention (e.g., components/methodologies described in the context of FIGS. 1-3) may be implemented, according to certain embodiments of the invention.

As shown, the techniques for controlling access to at least one resource may be implemented in accordance with a processor 410, a memory 412, I/O devices 414, and a network interface 416, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The flowchart and block diagrams in the figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be appreciated that any of the elements described hereinabove may be implemented as a computer program product embodied in a computer-readable medium, such as in the form of computer program instructions stored on magnetic or optical storage media or embedded within computer hardware, and may be executed by or otherwise accessible to a computer (not shown).

While the methods and apparatus herein may or may not have been described with reference to specific computer hardware or software, it is appreciated that the methods and apparatus described herein may be readily implemented in computer hardware or software using conventional techniques.

While the invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A computer implemented method for enabling communications between a business process and an external entity, comprising:
receiving notification data from a business process of a computer-based business process management system;
applying a set of rules to any of the notification data to
select an external entity to whom a communication will be sent,
select a communications channel from among a plurality of communications channels associated with the external entity, and
generate the communication from any of the notification data in a manner that conforms to the selected communications channel; and
sending the communication to the external entity via the selected communications channel.

2. The method of claim 1, wherein the applying further comprises:
applying any of the rules to a combination of static attributes and dynamic attributes associated with the external entity to select the external entity,
wherein the static attributes are attributes that require manual updating, and
wherein the dynamic attributes are attributes that are automatically updated substantially in real-time and without direct human intervention.

3. The method of claim 1, wherein the applying further comprises:
generating the communication in a human-consumable format.

4. The method of claim 1, wherein the applying further comprises:
providing the external entity with additional data that is relevant to the notification data.

5. The method of claim 1, further comprising:
receiving reply data from the external entity; and
providing any of the reply data to the business process in a format that is consumable by the business process.

6. The method of claim 1, wherein the applying further comprises:
for each of a plurality of external entities, selecting the external entity and the communications channel; and
initiating a collaborative communications session between the plurality of external entities.

7. The method of claim 1, further comprising:
receiving a reply from the external entity indicating that the external entity is unavailable;
applying any rules in the rules database to any of the notification data to
select a second external entity to whom a communication will be sent,
select a communications channel from among a plurality of communications channels associated with the second external entity, and
generate the communication from any of the notification data in a manner that conforms to the secondly selected communications channel; and
sending the communication to the second external entity via the secondly selected communications channel.

8. The method of claim 1, further comprising:
performing the applying and the sending for a different external entity in the absence of a reply received from the external entity within a predefined amount of time after the communication is sent to the external entity.

9. The method of claim 1, further comprising:
maintaining any of the notification data and the communication in a history data file on a computer-readable data storage device.

10. The method of claim 1, further comprising:
maintaining any of the notification data, the communication, and reply data in a history data file on a computer-readable data storage device.

11. A system for enabling communications between a business process and an external entity, the system comprising:
a processor;
a mediator configured to receive notification data from a business process of a computer-based business process management system; and
a rules database stored on a computer-readable data storage device;
where the mediator is configured to:
apply any rules in the rules database to any of the notification data to
select an external entity to whom a communication will be sent,
select a communications channel from among a plurality of communications channels associated with the external entity, and
generate the communication from any of the notification data in a manner that conforms to the selected communications channel; and
send the communication to the external entity via the selected communications channel.

12. The system of claim 11, wherein the mediator is further configured to:
apply any of the rules to a combination of static attributes and dynamic attributes associated with the external entity to select the external entity,
wherein the static attributes are attributes that require manual updating, and
wherein the dynamic attributes are attributes that are automatically updated substantially in real-time and without direct human intervention.

13. The system of claim 11, wherein the mediator is configured to:
receive reply data from the external entity, and
provide any of the reply data to the business process in a format that is consumable by the business process.

14. The system of claim 11 where the mediator is configured to:
for each of a plurality of external entities, select the external entity and the communications channel; and
initiate a collaborative communications session between the external entities.

15. The system of claim 11, wherein the mediator is configured to:
receive a reply from the external entity indicating that the external entity is unavailable;
apply any rules in the rules database to any of the notification data to
select a second external entity to whom a communication will be sent,
select a communications channel from among a plurality of communications channels associated with the second external entity, and
generate the communication from any of the notification data in a manner that conforms to the secondly selected communications channel; and
send the communication to the second external entity via the secondly selected communications channel.

16. A computer program product for enabling communications between a business process and an external entity, the computer program product comprising:
a computer-readable storage medium; and
computer-readable program code embodied in said computer-readable storage medium, wherein said computer-readable program code is configured to:
receive notification data from a business process of a computer-based business process management system,
apply a set of rules to any of the notification data to
select an external entity to whom a communication will be sent,
select a communications channel from among a plurality of communications channels associated with the external entity, and
generate the communication from any of the notification data in a manner that conforms to the selected communications channel; and
send the communication to the external entity via the selected communications channel.

17. The computer program product of claim 16, wherein said computer-readable program code is configured to:
apply any of the rules to a combination of static attributes and dynamic attributes associated with the external entity to select the external entity,
wherein the static attributes are attributes that require manual updating, and
wherein the dynamic attributes are attributes that are automatically updated substantially in real-time and without direct human intervention.

18. The computer program product of claim 16, wherein said computer-readable program code is configured to:
generate the communication in a human-consumable format.

19. The computer program product of claim 16, wherein said computer-readable program code is configured to:
provide the external entity with additional data that is relevant to the notification data.

20. The computer program product of claim 16, wherein said computer-readable program code is configured to:
receive reply data from the external entity, and
provide any of the reply data to the business process in a format that is consumable by the business process.

21. The computer program product of claim 16, wherein said computer-readable program code is configured to:
for each of a plurality of external entities, select the external entity and the communications channel; and
initiate a collaborative communications session between the external entities.

22. The computer program product of claim 16, wherein said computer-readable program code is configured to:
receive a reply from the external entity indicating that the external entity is unavailable;
apply any rules in the rules database to any of the notification data to
select a second external entity to whom a communication will be sent,
select a communications channel from among a plurality of communications channels associated with the second external entity, and
generate the communication from any of the notification data in a manner that conforms to the secondly selected communications channel; and
send the communication to the second external entity via the secondly selected communications channel.

23. The computer program product of claim 16, wherein said computer-readable program code is configured to:
perform the applying and the sending for a different external entity in the absence of a reply received from the external entity within a predefined amount of time after the communication is sent to the external entity.

24. The computer program product of claim 16, wherein said computer-readable program code is configured to:
maintain any of the notification data and the communication in a history data file on a computer-readable data storage device.

25. The computer program product of claim 16, wherein said computer-readable program code is configured to:
maintain any of the notification data, the communication, and reply data in a history data file on a computer-readable data storage device.
